(19) United States
(12) Patent Application Publication
(10) Pub. No.: US 2011/0206277 A1
(43) Pub. Date: Aug. 25, 2011

(54) IMAGE PROCESSING APPARATUS AND STORAGE MEDIUM HAVING STORED THEREIN AN IMAGE PROCESSING APPARATUS PROGRAM

(75) Inventor: Naoya MATSUMOTO, Tokyo (JP)

(73) Assignee: CASIO COMPUTER CO., LTD., Tokyo (JP)

(21) Appl. No.: 13/025,505

(22) Filed: Feb. 11, 2011

(30) Foreign Application Priority Data
Feb. 22, 2010 (JP) 2010-036637

(51) Int. Cl. G06K 9/00

(52) U.S. Cl. 382/165

(57) ABSTRACT

A processing object selection unit (for large size) 53 selects data of a plurality of pixels to be processed in texture processing from among YUV components of an original image. An orientation decision unit (for large size) 54 determines orientation of a brush stroke pattern using edge intensity of a Y component in horizontal and vertical directions for each of predetermined unit of pixels of the original image. A texture processing unit (for large size) 55 carries out first texture processing on data of the plurality of pixels selected by the processing object selection unit (for large size) 53 using colors of the pixels and the brush stroke pattern of the orientation determined by the orientation decision unit (for large size) 54. Also, second texture processing similar to the first is carried out only near the edge portion of the image by a processing object selection unit (for small size) 56, an orientation decision unit (for small size) 57, and a texture processing unit (for small size) 58. In this way, it is possible to generate data of an image with enhanced artistically creative effects by taking into account an original image as a whole.

### BACKGROUND OF THE INVENTION

This application is based on and claims the benefit of priority from Japanese Patent Application No. 2010-036637 filed on Feb. 22, 2010, the content of which is incorporated herein by reference.

### FIELD OF THE INVENTION

The present invention relates to an image processing apparatus and a storage medium having stored therein an image processing program, and more particularly to a technology of image processing that can generate data of an image with enhanced artistically creative effects by taking into account an original image as a whole, as image processing to acquire an image of high artistic quality from the original image.

### RELATED ART

Recently, for the purpose of enhancing artistically creative effects of an image acquired by photographing or the like, image processing of applying enhanced artistic effects to data of an original image has been carried out.

In order to achieve the above described purpose, for example, Japanese Patent Application Publication No. 1996-044867 discloses a technique that acquires information of luminance, saturation, and hue for each pixel of an original image, and uses this information to simulate brush strokes and colors in units of pixels of artistic paintings such as watercolor and oil paintings, when data of the original image is converted to realize artistic enhancement.

However, the simulation carried out by the technique disclosed in Japanese Patent Application Publication No. 1996-044867 simulates in units of pixels only and therefore lacks an artistic effect taking into account the image as a whole.

The present invention was conceived in view of above problem, and it is an object of the present invention to provide a technique of image processing of acquiring an image of high artistic quality from an original image, and further, by taking into account the original image as a whole, generating data of an image of higher artistic quality.

### SUMMARY OF THE INVENTION

In order to attain the above object, in accordance with a first aspect of the invention, there is provided an image processing apparatus including:

an input unit that inputs data of an image; a conversion unit that converts the data of the image inputted by the input unit into a form including a color space having a luminance component;

a selection unit that selects data of a plurality of pixels from data of the image converted by the conversion unit;

a first determining unit that determines orientation of a brush stroke pattern for texture processing based on an edge intensity of each predetermined unit of pixel of the image, in horizontal and vertical directions;

a first texture processing unit that carries out the texture processing on data of the plurality of pixels selected by the selection unit using colors of the pixels, with the brush stroke pattern of the orientation determined by the first determining unit; and

a storing control unit that controls storing the data of the image including a result of processing carried out by the first texture processing unit.

In order to attain the above object, in accordance with a second aspect of the invention, there is provided a storage medium having stored therein an image processing program causing a computer to perform image processing on data of an image inputted therein to function as:

a conversion function that converts the data of the image inputted therein into a form including a color space having a luminance component;

a selection function that selects data of a plurality of pixels from data of the image converted by the conversion function;

a determining function that determines orientation of a brush stroke pattern for texture processing based on an edge intensity of each predetermined unit of pixel of the image in horizontal and vertical directions;

a texture processing function that carries out the texture processing on data of the plurality of pixels selected by the selection function using colors of the pixels, with the brush stroke pattern of the orientation determined by the determining function; and

a storing control function that controls storing the data of the image including a result of processing carried out by the texture processing function.

According to the present invention, it is possible to realize image processing that can generate data of an image with enhanced artistically creative effects by taking into account an original image as a whole, as image processing to acquire an image of high artistic quality from the original image.

### BRIEF DESCRIPTION OF THE DRAWINGS

FIG. 1 is a block diagram showing a hardware configuration of an image capturing apparatus according to one embodiment of the present invention;

FIG. 2 is a functional block diagram showing a functional configuration of the image capturing apparatus shown in FIG. 1;

FIG. 3 is a flowchart showing one example of flow of oil-painting-like image generation processing carried out by the image capturing apparatus shown in FIG. 2;

FIG. 4 is a diagram illustrating one example of a result of the process of step S4 of the oil-painting-like image generation processing of FIG. 3;

FIG. 5 is a diagram illustrating one example of a result of the process of step S5 of the oil-painting-like image generation processing of FIG. 3;

FIG. 6 is a diagram illustrating one example of a result of the process of step S6 of the oil-painting-like image generation processing of FIG. 3;

FIG. 7 is a diagram illustrating one example of brush stroke patterns selectable in brush stroke pattern decision processing of step S3 of the oil-painting-like image generation processing of FIG. 3;

FIG. 8 is a diagram illustrating one example of a Sobel filter used to calculate edge intensity employed in the brush stroke pattern decision processing of step S3 of the oil-painting-like image generation processing of FIG. 3;

FIG. 9 is a flowchart showing one example of flow of orientation selection processing executed to select orientation of brush stroke pattern for a predetermined unit of pixel as a part of the brush stroke pattern decision processing of step S3 of the oil-painting-like image generation processing of FIG. 3;

FIG. 10 is a diagram illustrating one example of an oil-painting-like image acquired as a result of the oil-painting-like image generation processing of FIG. 3;

FIG. 11 is an enlarged view of a partial area of the oil-painting-like image of FIG. 10; and

FIG. 12 is an enlarged view of a partial area of the oil-painting-like image of FIG. 10, which is different from the area of FIG. 11.

### DETAILED DESCRIPTION OF THE INVENTION

The following describes an embodiment of the present invention with reference to the drawings.

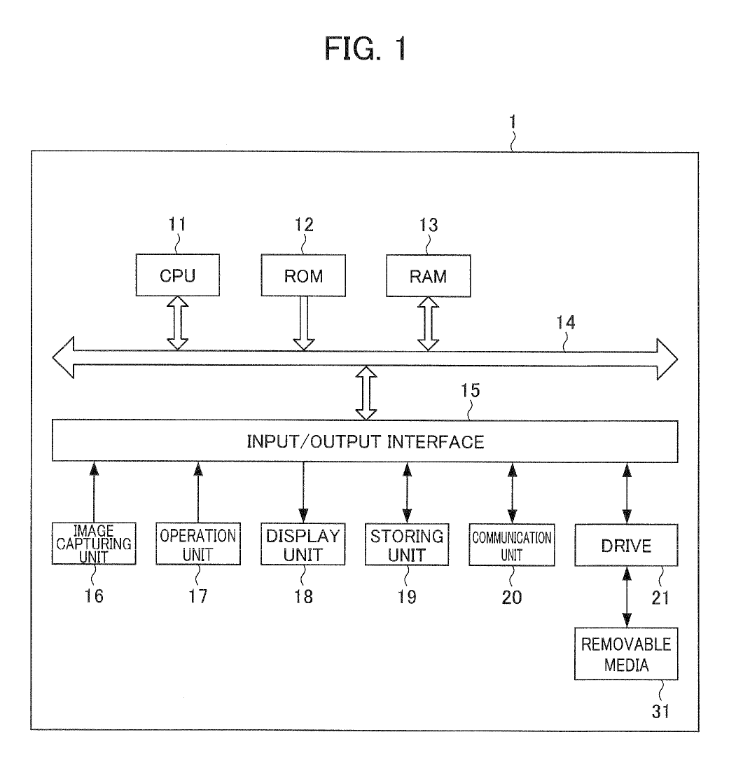

FIG. 1 is a block diagram showing a hardware configuration of the image capturing apparatus 1 as one embodiment of image processing apparatus according to the present invention. The image capturing apparatus 1 can be configured by a digital camera, for example.

The image capturing apparatus 1 is provided with a CPU (Central Processing Unit) 11, a ROM (Read Only Memory) 12, a RAM (Random Access Memory) 13, a bus 14, an input/output interface 15, an image capturing unit 16, an operation unit 17, a display unit 18, a storing unit 19, a communication unit 20, and a drive 21.

The CPU 11 executes various processes according to programs that are stored in the ROM 12. Alternatively, the CPU 11 executes various processes according to programs that are loaded from the storing unit 19 to the RAM 13.

The RAM 13 also stores data and the like necessary for the CPU 11 to execute the various processes as appropriate.

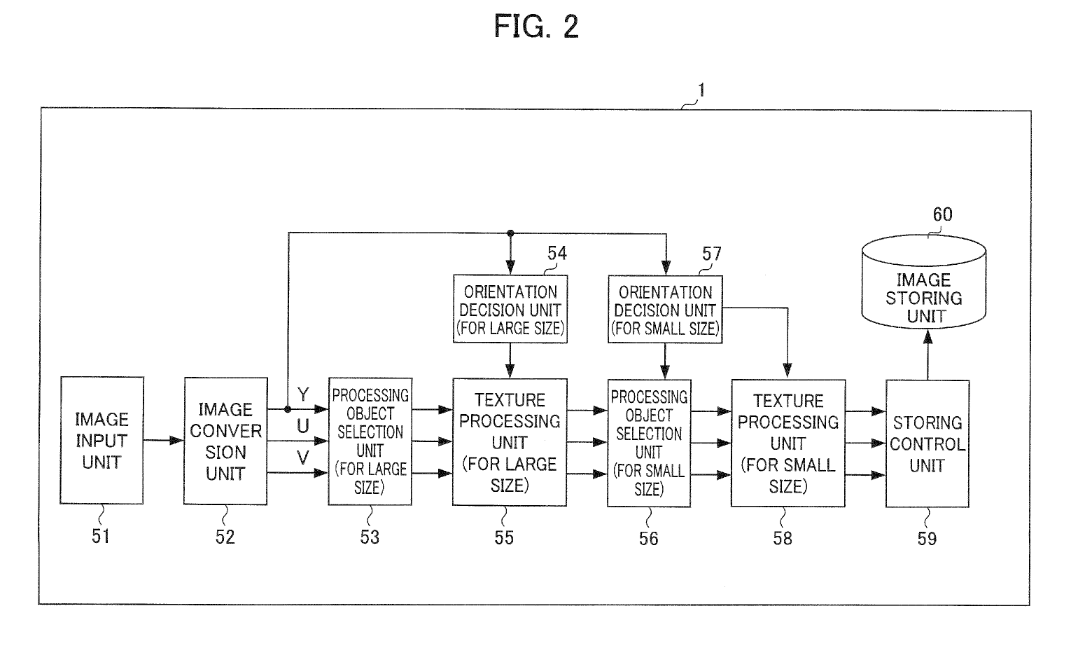

For example, according to the present embodiment, programs for implementing functions of an image conversion unit 52, a processing object selection unit (for large size) 53, an orientation decision unit (for large size) 54, a texture processing unit (for large size) 55, a processing object selection unit (for small size) 56, an orientation decision unit (for small size) 57, a texture processing unit (for small size) 58, a storing control unit 59 shown in FIG. 2, which will be described later, are stored in the ROM 12 or the storing unit 19. Therefore, each of the functions of the image conversion unit 52, the processing object selection unit (for large size) 53, the orientation decision unit (for large size) 54, the texture processing unit (for large size) 55, the processing object selection unit (for small size) 56, the orientation decision unit (for small size) 57, the texture processing unit (for small size) 58, the storing control unit 59 can be realized by the CPU 11 executing the processes according to these programs.

The CPU 11, the ROM 12, and the RAM 13 are connected to each other via the bus 14. The bus 14 is also connected with the input/output interface 15. The image capturing unit 16, the operation unit 17, the display unit 18, the storing unit 19, and the communication unit 20 are connected to the input/output interface 15.

The image capturing unit 16 is provided with an optical lens unit and an image sensor, which are not illustrated in the drawings.

The optical lens unit is configured by a light condensing lens such as a focus lens, a zoom lens, and the like, for example, to photograph a subject. The focus lens is a lens to form an image of a subject on the light receiving surface of the image sensor. The zoom lens is a lens to freely change a focal point within a predetermined range. The optical lens unit includes peripheral circuits to adjust parameters such as focus, exposure, white balance, and the like as necessary.

The image sensor is configured by an optoelectronic conversion device, an AFE (Analog Front End), and the like.

The optoelectronic conversion device is configured by a CMOS (Complementary Metal Oxide Semiconductor) type optoelectronic conversion device, or the like, for example. An image of a subject is incident through the optical lens unit on the optoelectronic conversion device. The optoelectronic conversion device optoelectronically converts (i.e. captures) an image of a subject as an image signal at a predetermined interval, stores the image signal thus converted, and sequentially supplies the stored image signal to the ATE as an analog signal. The AFE executes various kinds of signal processing such as A/D (Analog/Digital) conversion on the analog image signal. As a result of the various kinds of signal processing, a digital signal is generated and outputted as an output signal from the image capturing unit 16.

Hereinafter, the output signal from the image capturing unit 16 is referred to as “data of a captured image” . Thus, data of a captured image is outputted from the image capturing unit 16 to be provided as appropriate to the CPU 11 and the like.

The operation unit 17 is configured by various buttons and receives a user operation instruction. The display unit 18 displays various images. The storing unit 19 is configured by a DRAM (Dynamic Random Access Memory) and the like and temporarily stores data of captured images outputted from the image capturing unit 16. Also, the storing unit 19 stores various kinds of data necessary for various kinds of image processing, such as image data, values of various flags, threshold values, and the like. The communication unit 20 controls communication with other devices (not shown) via networks including the Internet.

The input/output interface 15 is connected with the drive 21 as necessary, and removable media 31 such as a magnetic disk, an optical disk, a magneto-optical disk, or a semiconductor memory is mounted to the drive as appropriate. Also, programs read from such media are installed in the storing unit 19. Furthermore, similar to the storing unit 19, the removable media 31 can store various kinds of data such as image data and the like, stored in the storing unit 19.

FIG. 2 is a functional block diagram showing a functional configuration of the image capturing apparatus 1 to carry out the oil-painting-like image generation processing. Here, the oil-painting-like image generation processing refers to processing of generating data of an image (hereinafter referred to as “oil-painting-like image”) that resembles an oil painting painted with a brush, which is a kind of artwork having high artistic quality, from data of an initial image (hereinafter referred to as “original image”) input as a target for image processing.

As shown in FIG. 2, the image capturing apparatus 1 includes an image input unit 51, an image conversion unit 52, a processing object selection unit (for large size) 53, an orientation decision unit (for large size) 54, a texture processing unit (for large size) 55, a processing object selection unit (for small size) 56, an orientation decision unit (for small size) 57, a texture processing unit (for small size) 58, a storing control unit 59, and an image storing unit 60 in order to implement the oil-painting-like image generation processing.

In the present embodiment, from among the constituent elements shown in FIG. 1, the image input unit 51 includes the image capturing unit 16, the communication unit 20, the drive 21; and the like, and inputs data of an original image. This means that, in the present embodiment, the image input unit 51 inputs, as data of an original image, not only data of a captured image outputted from the image capturing unit 16 but also data of an image transmitted from another device and received by the communication unit 20, data of an image read out by the drive 21 from the removable media 31, and the like.

In the present embodiment, each of the image conversion unit 52, the processing object selection unit (for large size) 53, the orientation decision unit (for large size) 54, the texture processing unit (for large size) 55, the processing object selection unit (for small size) 56, the orientation decision unit (for small size) 57, the texture processing unit (for small size) 58, and the storing control unit 59 is configured as a combination of the CPU 11 as hardware, and programs stored in the ROM 12 and the like as software, from among the constituent elements shown in FIG. 1.

Also, the image storing unit 60 is configured as an area in the RAM 13 or the storing unit 19 of the image capturing apparatus 1 or in the removable media 31, from among the constituent elements shown in FIG. 1.

The image conversion unit 52 carries out processing to convert the original image of the data inputted to the image input unit 51 from a form at the time of input, into a form including a color space having a luminance component. Such processing is hereinafter referred to as “image conversion processing”.

As the destination color space of the image conversion processing of the present embodiment, what is referred to as a YUV space is employed as shown in FIG. 2. This means that, in the present embodiment, as a result of the image conversion processing by the image conversion unit 52, data of an original image consisting of a luminance component (hereinafter referred to as “Y component”), a color difference component between luminance and blue (hereinafter referred to as “U component”), and a color difference component between luminance and red (hereinafter referred to as “V component”) is acquired.

Hereinafter, data of the Y component, the U component, and the V component of an image is inclusively referred to as “YUV component(s)”.

The processing object selection unit (for large size) 53 selects a plurality of pixels as objects of texture processing from among YUV components of the original image outputted from the image conversion unit 52.

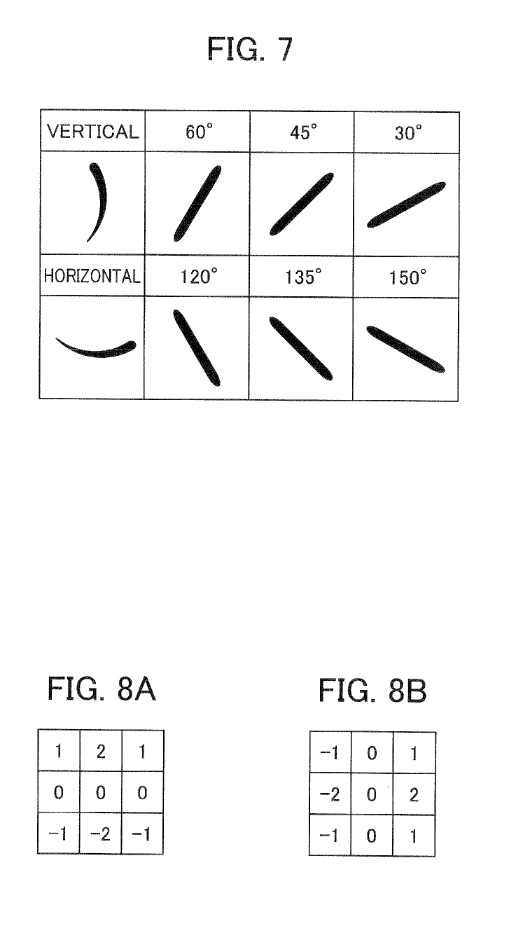

Here, the texture processing is referred to as image processing that adds simulated textures of oil painting strokes of a brush or the like onto an image. A pattern of such “simulated texture of a brush stroke or the like” is referred to as “brush stroke pattern” in the present specification. The form, size, and the like of a texture employed as a brush stroke pattern are not limited. In the present embodiment, however, a brush-like pattern such as a brush stroke pattern of a brush painting of an oil painting is employed. As orientation of brush stroke patterns of the brush stroke, N kinds of orientation are determined in advance. Here, N is an integer greater than one. As shown in FIG. 7, N is set to 8 in the present embodiment, which will be described later.

The orientation decision unit (for large size) 54 determines one kind of orientation of the brush stroke pattern to be used in the texture processing for each predetermined unit of pixel from among 8 kinds of orientation shown in FIG. 7, which will be described later, according to an edge intensity of a Y component in horizontal and vertical directions for each predetermined unit of pixel of the original image outputted from the image conversion unit

The texture processing unit (for large size) 55 carries out the texture processing on data of the plurality of pixels selected by the processing object selection unit (for large size) 53 using colors of the pixels and the brush stroke pattern of the kind of orientation determined by the orientation decision unit (for large size) 54 from among 8 kinds of orientation shown in FIG. 7, which will be described later. Data of an oil-painting-like image is thus acquired by repeating such texture processing for data of each of a plurality of pixels.

Here, the “texture processing using colors of the pixels” described above includes not only processing of adding texture of the pixel color as it is, but also processing of adding texture of a color calculated using the color information of the pixels. As the texture color, in the present embodiment, a color is employed that is expressed by a random value plus a value calculated based on the luminance of the texture and the color information (each YUV component value) of the pixel at a position where the texture is added. The color of the texture tends to be selected randomly. However, since not only a random value but also the color information of the pixel at a position where the texture is added is used in addition to the random value, the color of the texture thus selected becomes close to the color of the original image.

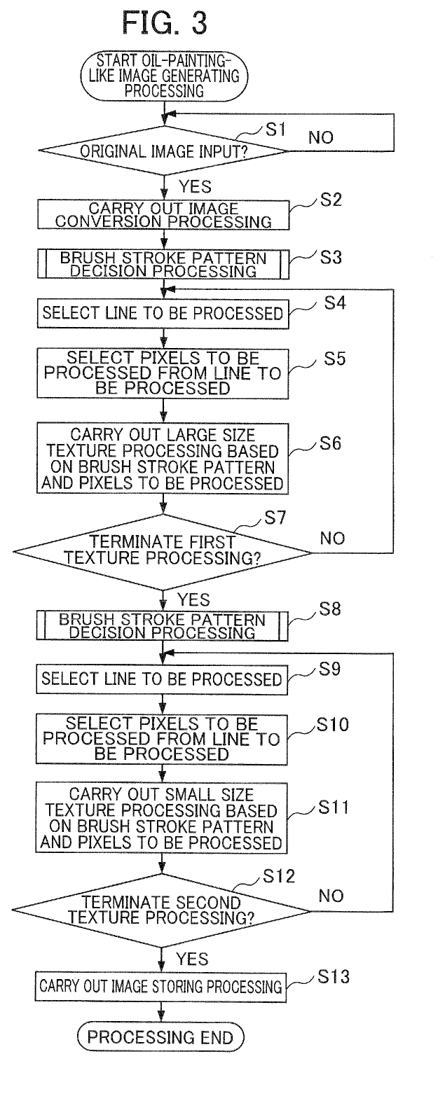

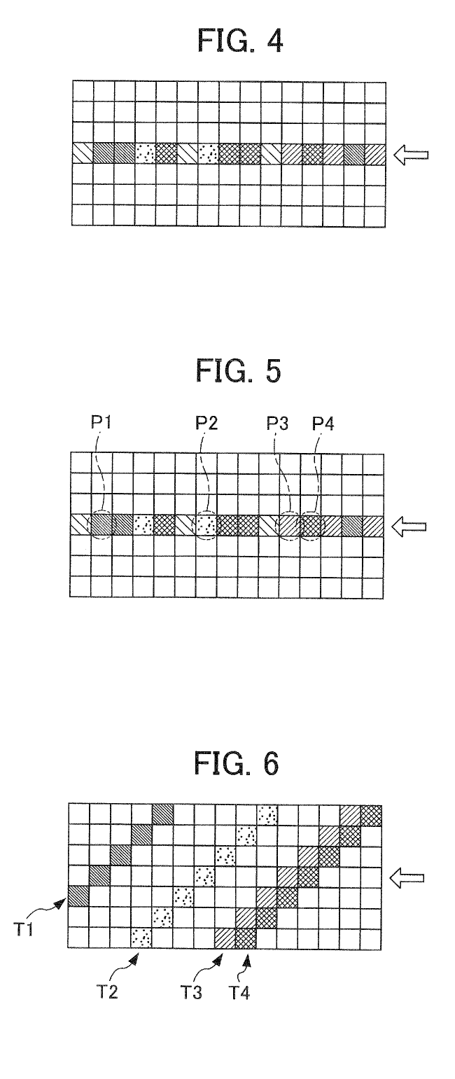

Further details of the processing carried out by the processing object selection unit (for large size) 53, the orientation decision unit (for large size) 54, and the texture processing unit (for large size) 55 will be described later as processes of steps S3 to S7 of FIG. 3, with reference to FIGS. 4 to 9.

As a result of such texture processing carried out by the processing object selection unit (for large size) 53, the orientation decision unit (for large size) 54, and the texture processing unit (for large size) 55 for the first time, data of an oil-painting-like image is acquired. In the present embodiment, however, in order to complement the edge portion of the oil-painting-like image, texture processing is carried out a second time.

For carrying out the second texture processing, the image capturing apparatus 1 includes a processing object selection unit (for small size) 56, an orientation decision unit (for small size) 57, and a texture processing unit (for small size) 58.

The processing object selection unit (for small size) 56 selects data of a plurality of pixels as objects of the second texture processing from data of the oil-painting-like image acquired as a result of the first texture processing by the processing object selection unit (for large size) 53, the orientation decision unit (for large size) 54, and the texture processing unit (for large size) 55.

The orientation decision unit (for small size) 57 determines one kind of orientation of the brush stroke pattern for use in the texture processing for each predetermined unit of pixel from among 8 kinds of orientation shown in FIG. 7, which will be described later, according to an edge intensity of a Y component in horizontal and vertical directions for each predetermined unit of pixel of the original image outputted from the image conversion unit 52. Here, the orientation decision unit (for small size) 57 determines the orientation of a brush stroke pattern smaller than the one determined by the orientation decision unit (for large size) 54.

The texture processing unit (for small size) 58 carries out the second texture processing on data of the plurality of pixels selected by the processing object selection unit (for small size) 56 using colors of the pixels and the brush stroke pattern of the orientation determined by the orientation decision unit (for small size) 57.

By repeating such second texture processing for data of each of a plurality of pixels, data of the oil-painting-like image having complemented edge portions is thus acquired.

Further details of the processing carried out by the processing object selection unit (for small size) 56, the orientation decision unit (for small size) 57, and the texture processing unit (for small size) 58 will be described later as processes of steps S8 to S12 of FIG. 3.

The storing control unit 59 carries out control processing (hereinafter referred to as “image storing processing”) of storing in the image storing unit 60 the data of the oil-painting-like image processed in the second texture processing by the texture processing unit (for small size) 58.

In the following, a description is given concerning the oil-painting-like image generation processing carried out by the image capturing apparatus 1 having such a functional configuration.

FIG. 3 is a flowchart showing one example of flow of the oil-painting-like image generation processing.

In step S1, the image input unit 51 determines whether or not data of an original image is input: If data of an original image is not input, NO is determined in step S1, and the determining process of step Si is executed again. This means that the oil-painting-like image generation processing enters into a waiting state by repeating the determining process of step S1 until data of an original image is input.

After that, when data of an original image is inputted to the image input unit 51, YES is determined in step Si, and control proceeds to step S2.

In step S2, the image conversion unit 52 carries out the image conversion processing on data of the original image inputted to the image input unit 51. As a result of this, in the present embodiment, YUV components of the original image are acquired as described above.

In step S3, the orientation decision unit (for large size) 54 determines the orientation of a brush stroke pattern for the texture processing by calculating edge intensity of the Y component in horizontal and vertical directions for each predetermined unit of pixel of the original image after processing in the image conversion processing in step S2.

Hereinafter, this type of processing of step S3 is referred to as “brush stroke pattern decision processing”. The brush stroke pattern decision processing will be described later in detail with reference to FIGS. 7 to 9.

In step S4, the processing object selection unit (for large size) 53 selects an arbitrary line from among a plurality of lines of the YUV components as a line to be processed. In step S5, the processing object selection unit (for large size) 53 selects a plurality of pixels to be processed from among the lines to be processed. For example, the processing object selection unit (for large size) 53 generates a random value and selects a plurality of pixels from the pixels constituting the line to be processed, using the random value thus generated.

In step S6, the texture processing unit (for large size) 55 carries out the first texture processing described above based on the brush stroke pattern of the orientation determined in the brush stroke pattern decision processing in step S3 and the plurality of pixels to be processed selected in the process of step S5. Here, the processes of steps S3 to S7 are inclusively referred to as “first texture processing”, and the process of step S6 is restrictively referred to as “large size texture processing”.

In the following, the processes of steps S4 to S6 are specifically described with reference to FIGS. 4 to 6.

FIG. 4 is a diagram illustrating one example of a result of the process of step S4. FIG. 5 is a diagram illustrating one example of a result of the process of step S5. FIG. 6 is a diagram illustrating one example of a result of the process of step S6. FIGS. 4 to 6 show the same partial area within the image expressed by the YUV components. In FIGS. 4 to 6, one square denotes one pixel.

In the present example, in the process of step S4, the fourth line from the top in the drawing area of FIG. 4 is selected to be processed, as shown by the white arrow in FIG. 4. In the process of step S5, four pixels P1 to P4 are selected to be processed from among the pixels constituting the line to be processed, as shown in FIG. 5.

Here, for ease of description, in the brush stroke pattern decision processing of step S3, a brush stroke pattern of 45 degree orientation, among brush stroke patterns of 8 kinds of orientation shown in FIG. 7, which will be described later, is assumed to be selected for each of four pixels P1 to P4.

In this case, in the process of step S6, as shown in FIG. 6, textures T1 to T4 are added at positions of the respective four pixels P1 to P4. The textures T1 to T4 are brush stroke patterns of 45 degree orientation and have colors calculated based on the pixel values (values of YUV components) of the respective four pixels P1 to P4.

Here, in the example of FIG. 6, for ease of description a brush stroke pattern of the same (45 degree) orientation is employed for each one of four pixels P1 to P4. However, in an actual case, the kinds of orientation of textures added to the four pixels P1 to P4 are not necessarily the same, since orientation is selected for each pixel in the brush stroke decision processing of step S3.

In the following, the brush stroke pattern decision processing of step S3 will be described in detail with reference to FIGS. 7 to 9.

FIG. 7 is a diagram illustrating one example of an assortment of brush stroke patterns selectable in the brush stroke pattern decision processing of step S3, In the present embodiment, as shown in FIG. 7, brush stroke patterns of 8 kinds of orientation, i.e. 90 degree (vertical), 60 degree, 45 degree, 30 degree, 0 degree (horizontal), 120 degree, 135 degree, and 150 degree of orientation with respect to a horizontal line from left to right in FIG. 7 are defined in advance.

Therefore, in the present embodiment, the brush stroke pattern decision processing of step S3 is carried out on the Y component of the original image as a processing object after processing in the image conversion processing of step S2 in FIG. 3. As a result, a brush stroke pattern of one kind of orientation is selected from among the 8 kinds of orientation shown in FIG. 7 for each predetermined unit of pixel of the Y component.

More specifically, for example, the orientation decision unit (for large size) 54 shown in FIG. 2 carries out reducing processing on the Y component of the original image after processing in the image conversion processing of step S2, to generate data of a QVGA (Quarter Video Graphics Array) size.

Next, the orientation decision unit (for large size) 54 acquires edge intensity in horizontal and vertical directions by applying respective Sobel filters shown in FIG. 8 to data of each pixel constituting the data of QVGA size.

FIG. 8 is a diagram illustrating one example of a Sobel filter for 3 horizontal pixels by 3 vertical pixels. More specifically, FIG. 8A is a diagram illustrating one example of a Sobel filter for detecting a vertical component, and FIG. 83 is a diagram illustrating one example of a Sobel filter for detecting a horizontal component.

The orientation decision unit (for large size) 54 determines data of a predetermined unit of pixel from among the pixels constituting the data of the QVGA size as data of an attention pixel to be processed. The orientation decision unit (for large size) 54 applies the sobel filter for detecting a vertical component shown in FIG. 8A and the sobel filter for detecting a horizontal component shown in FIG. 8B to the data of the attention pixel. Here, a value acquired by applying the sobel filter for detecting a vertical component shown in FIG. 8A to the data of the attention pixel is a vertical edge intensity. Such a vertical edge intensity is hereinafter referred to as “Sobel (vertical)” or more simply referred to as “vertical component”.

Also, a value acquired by applying the sobel filter for detecting a horizontal component shown in FIG. 8B to the data of the attention pixel is a horizontal edge intensity. Such a horizontal edge intensity is hereinafter referred to as “Sobel (horizontal)” or more simply referred to as “horizontal component”.

Next, based on such Sobel (vertical) and Sobel (horizontal), the orientation decision unit (for large size) 54 determines a brush stroke pattern of one orientation fitting for data of the attention pixel from among 8 kinds of orientation shown in FIG. 7. Hereinafter, such processing is referred to as “orientation selection processing”.

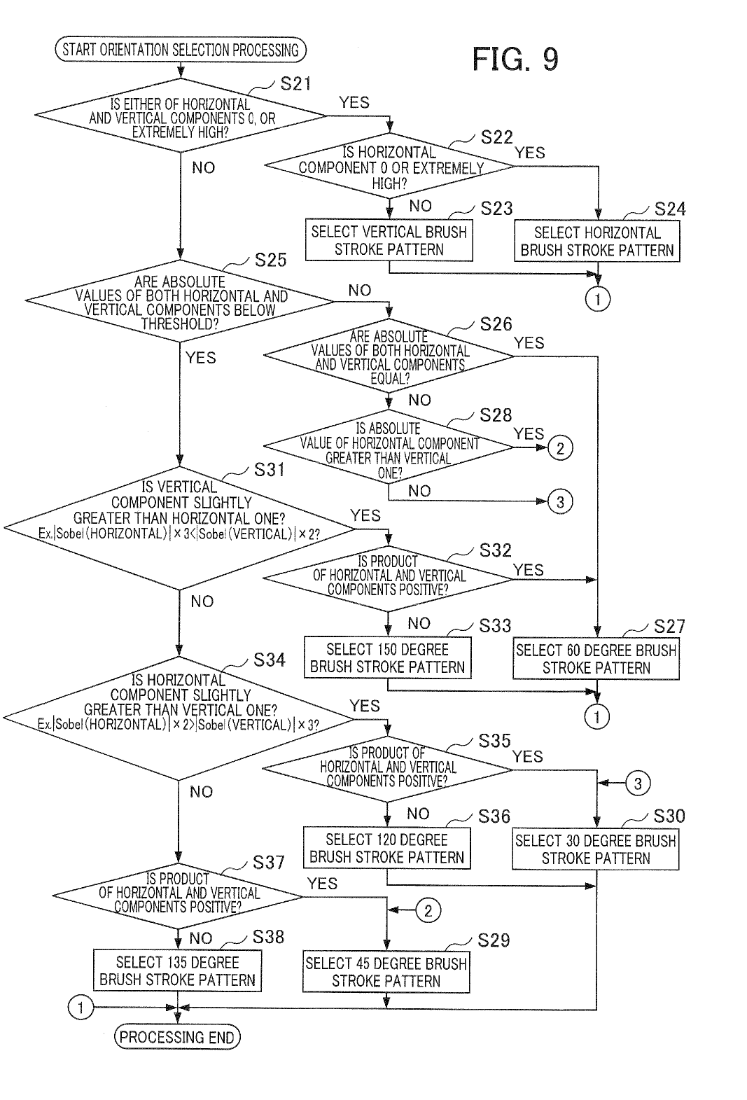

FIG. 9 is a flowchart showing one example of flow of the orientation selection processing.

In step S21, the orientation decision unit (for large size) 54 determines whether or not either of horizontal and vertical components is zero or extremely high.

If either of the horizontal and vertical components is zero or extremely high, YES is determined in step S21, and control proceeds to step S22. In step S22, the orientation decision unit (for large size) 54 determines whether or not the horizontal component is zero or extremely high.

If the vertical component is zero or extremely high, NO is determined in step S22, and control proceeds to step S23. In step S23, the orientation decision unit (for large size) 54 selects the brush stroke pattern of vertical orientation. With this, the orientation selection processing ends.

On the other hand, if the horizontal component is zero or extremely high, YES is determined in step S22, and control proceeds to step S24. In step S24, the orientation decision unit (for large size) 54 selects the brush stroke pattern of horizontal orientation. With this, the orientation selection processing ends.

Alternatively, if both of the horizontal and vertical components cannot be determined to be zero nor extremely high, NO is determined in step S21, and control proceeds to step S25. In step S25, the orientation decision unit (for large size) 54 determines whether or not the absolute values of the horizontal and vertical components are both lower than a threshold value.

If at least one of the absolute values of the horizontal and vertical components exceeds the threshold value, NO is determined in step S25, and control proceeds to step S26. In step S26, the orientation decision unit (for large size) 54 determines whether or not the absolute values of the horizontal and vertical components are equal to each other.

If the absolute values of the horizontal and vertical components are equal to each other, YES is determined in step S26, and control proceeds to step S27. In step S27, the orientation decision unit (for large size) 54 selects the brush stroke pattern of 60 degree orientation. With this, the orientation selection processing ends.

On the other hand, if the absolute values of the horizontal and vertical components are not equal to each other, NO is determined in step S26, and control proceeds to step S28. In step S28, the orientation decision unit (for large size) 54 determines whether or not the absolute value of the horizontal component is greater than the absolute value of the vertical component.

If the absolute value of the horizontal component is greater than the absolute value of the vertical component, YES is determined in step S28, and control proceeds to step S29. In step S29, the orientation decision unit (for large size) 54 selects the brush stroke pattern of 45 degree orientation. With this, the orientation selection processing ends.

On the other hand, if the absolute value of the horizontal component is less than the absolute value of the vertical component, i.e. the absolute value of the vertical component is greater than the absolute value of the horizontal component, NO is determined in step S28, and control proceeds to step S30. In step S30, the orientation decision unit (for large size) 54 selects the brush stroke pattern of 30 degree orientation. With this, the orientation selection processing ends.

Alternatively, if both of the horizontal and vertical components are below the threshold value, YES is determined in step S25, and control proceeds to step S31. In step S31, the orientation decision unit (for large size) 54 determines whether or not the absolute value of the vertical component is slightly greater than the absolute value of the horizontal component.

More specifically, for example, in step S31, it is determined whether or not the following inequation (1) is satisfied.

|Sobel(horizontal)|×3<|Sobel(vertical)|×2 (1)

If the absolute value of the vertical component is slightly greater than the absolute value of the horizontal component, more specifically, for example, if the inequation (1) described above is satisfied, YES is determined in step S31, and control proceeds to step S32.

In step S32, the orientation decision unit (for large size) 54 determines whether or not the product of the horizontal and vertical components is positive.

If the product of the horizontal and vertical components is positive, YES is determined in step S32, and control proceeds to step S27. In step S27, the orientation decision unit (for large size) 54 selects the brush stroke pattern of 60 degree orientation. With this, the orientation selection processing ends.

On the other hand, if the product of the horizontal and vertical components is negative, NO is determined in step S32, and control proceeds to step S33. In step S33, the orientation decision unit (for large size) 54 selects the brush stroke pattern of 150 degree orientation. With this, the orientation selection processing ends.

Alternatively, if the absolute value of the vertical component cannot be determined to be slightly greater than the absolute value of the horizontal component, more specifically, for example, if the inequation (1) described above is not satisfied, NO is determined in step S31, and control proceeds to step S34. In step S34, the orientation decision unit (for large size) 54 determines whether or not the absolute value of the horizontal component is slightly greater than the absolute value of the vertical component.

More specifically, for example, in step S34, it is determined whether or not the following inequation (2) is satisfied.

|Sobel(horizontal)|×2>|Sobel(vertical)|×3 (2)

If the absolute value of the horizontal component is slightly greater than the absolute value of the vertical component, more specifically, for example, if the inequation (2) described above is satisfied, YES is determined in step S34, and control proceeds to step S35. In step S35, the orientation decision unit (for large size) 54 determines whether or not the product of the horizontal and vertical components is positive.

If the product of the horizontal and vertical components is positive, YES is determined in step S35, and control proceeds to step S30. In step S30, the orientation decision unit (for large size) 54 selects the brush stroke pattern of 30 degree orientation. With this, the orientation selection processing ends.

On the other hand, if the product of the horizontal and vertical components is negative, NO is determined in step S35, and control proceeds to step S36. In step S36, the orientation decision unit (for large size) 54 selects the brush stroke pattern of 120 degree orientation. With this, the orientation selection processing ends.

On the other hand, if the absolute value of the horizontal component cannot be determined to be slightly greater than the absolute value of the vertical component, more specifically, for example, if the inequation (2) described above is not satisfied, NO is determined in step 534, and control proceeds to step S37. In step S37, the orientation decision unit (for large size) 54 determines whether or not the product of the horizontal and vertical components is positive.

If the product of the horizontal and vertical components is positive, YES is determined in step S37, and control proceeds to step S29. In step S29, the orientation decision unit (for large size) 54 selects the brush stroke pattern of 45 degree orientation. With this, the orientation selection processing ends.

On the other hand, if the product of the horizontal and vertical components is negative, NO is determined in step S37, and control proceeds to step S38. In step S38, the orientation decision unit (for large size) 54 selects the brush stroke pattern of 135 degree orientation. With this, the orientation selection processing ends.

As described above, after the image conversion processing is carried out in the process of step S2, the Y component of the original image is reduced, and as a result thereof, data of the QVGA size is acquired. From the resultant data of the QVGA size, data of a predetermined unit of pixel is selected as data of an attention pixel, to which a Sobel filter for detecting a vertical component shown in FIG. 8A and a Sobel filter for detecting a horizontal component shown in FIG. 8B are separately applied.

When the orientation selection processing of FIG. 9 is carried out by using Sobel (vertical) and Sobel (horizontal) acquired as a result of such processing, a brush stroke pattern of corresponding one kind of orientation from among 8 kinds of orientation shown in FIG. 7 is selected for data of the attention pixel.

Data of each pixel constituting the data of the QVGA size described above is selected as data of the attention pixel one after another, and the series of processes described above are repeatedly carried out. With this, for data of each pixel constituting the data of the QVGA size, a brush stroke pattern of corresponding orientation is selected independently.

This means that, in the present embodiment, a map is generated for storing information on a brush stroke pattern independently selected for each item of pixel data constituting the data of QVGA size. Such a map is hereinafter referred to as “texture selecting map”.

The orientation decision unit (for large size) 54 enlarges this type of texture selecting map of the QVGA size, and thus generates a texture selecting map of the size equal to the size of the original image. Each piece of data of such a texture selecting map of the size equal to the size of the original image indicates a brush stroke pattern of orientation selected for each pixel constituting data (YUV components) of the original image.

In the process of step S6 of FIG. 3, using such a texture selecting map of the original image size, a brush stroke pattern of orientation selected by the brush stroke pattern decision processing of step S3 is extracted for each of the plurality of pixels to be processed selected in the process of step S5. And then, a texture of the brush stroke pattern extracted for each of the plurality of pixels is added at a position of each of the plurality of pixels using a corresponding color of the pixel.

When such a process of step S6 ends, control proceeds to step S7.

In step S7, the texture processing unit (for large size) 55 determines whether or not the first texture processing ends. This means that the texture processing unit (for large size) 55 determines whether or not a condition to terminate the first texture processing is satisfied. If the condition to terminate the first texture processing is not satisfied, NO is determined in step S7, and control goes back to step S4 to repeat processes thereafter.

The condition to terminate the first texture processing is not limited. For example, any condition such as that a repeat count of the processes of steps S4 to S6 exceeds a threshold value can be employed.

Until the condition to terminate the first texture processing is satisfied, a loop processing from steps S4 to S7: NO is repeated. At each time of repetition, an arbitrary line from among the YUV components of the original image is selected, from which a plurality of pixels are selected to be processed, and the large size texture processing is respectively carried out on the plurality of pixels.

After that, when the condition to terminate the first texture processing is satisfied, YES is determined in step S7, and control proceeds to step S8.

At the time when control proceeds to step S8, data of the oil-painting-like image has been already acquired, as is described above. In the present embodiment, however, the processes of steps S8 to S12 are carried out again as second texture processing in order to complement the edge portion of the oil-painting-like image.

The processes of steps S8 to S12 as the second texture processing are almost similar to the respective processes of steps S3 to S7 as the first texture processing. Therefore, in the following, only the points where the processes of steps S8 to S12 as the second texture processing differs from the respective processes of steps S3 to S7 as the first texture processing will be described.

The acting subject of the processes of steps S8 to S12 as the second texture processing is not the same as the first texture processing but is as follows:

The process of step S8 is executed by the orientation decision unit (for small size) 57, the processes of steps S9 and S10 are executed by the processing object selection unit (for small size) 56, and the processes of steps S11 and S12 are executed by the texture processing unit (for small size) 58.

The method of step S10 of selecting the pixels to be processed and the method of step S5 are the same in that a plurality of pixels are selected from pixels constituting the line to be processed by generating random values, but different from each other in that the pixel to be processed is selected as follows:

In the process of step S10, the plurality of pixels selected by using the random values are not yet processing objects but only candidates. So, the processing object selection unit (for small size) 56 selects a pixel to be processed from among the plurality of candidate pixels by referring to the result of a Sobel filter at a position of each of the plurality of candidate pixels.

More specifically, for example, the orientation decision unit (for small size) 57 applies, in turn, the Sobel filter for extracting vertical component shown in FIG. 8A and the Sobel filter for extracting horizontal component shown in FIG. 8B to data of each of pixels constituting the data of the QVGA size as a part of the brush stroke pattern decision processing of step S8.

At this time, the results of the Sobel filters are of the QVGA size. Therefore, the orientation decision unit (for small size) 57 enlarges the results of the Sobel filters of the QVGA size, and thus, generates results of Sobel filters of a size the same as the original image size.

Then, in step S10, after selecting a plurality of candidate pixels by using random values, the processing object selection unit (for small size) 56 extracts the result of a Sobel filter at a position of each of the plurality of candidate pixels from the results of the Sobel filters of the size equal to the size of the original image size.

Further, the processing object selection unit (for small size) 56 selects candidate pixels as processing objects at respective positions where the absolute values of both horizontal and vertical components of the results of the Sobel filters exceed a threshold value from among the results of Sobel filters at positions of the plurality of candidate pixels.

Here, the threshold value employed for such a selection is independent of the threshold value employed in the orientation selection processing of FIG. 9, and therefore, may be identical thereto or may be different therefrom.

By carrying out the second texture processing of step S11 exclusively on the pixels thus selected to be processed, it becomes possible to add textures exclusively on the edge portion of the oil-painting-like image. Here, the processes of steps S8 to S12 are inclusively referred to as “second texture processing”, and the process of step S11 is restrictively referred to as “small size texture processing”.

The small size texture processing of step S11 is similar to the large size texture processing of step S6 in that a texture is added on a pixel to be processed, but is different from the large size texture processing of step S6 in that the size of the texture employed in the small size texture processing is not equal to that of the one employed in the large size texture processing, but reduced.

When such small size texture processing of step S11 ends, control proceeds to step S12. In step S12, the small size texture processing unit 58 determines whether or not the second texture processing ends. This means that the small size texture processing unit 58 determines whether or not a condition to terminate the second texture processing is satisfied.

The condition to terminate the second texture processing is not limited. For example, any condition such as that a repeat count of the processes of steps S9 to S12 exceeds a threshold value can be employed. Here, the repeat count is independent of the repeat count employed in the condition to terminate the first texture processing of step S7, and therefore, may be identical thereto or may be different therefrom.

Until the condition to terminate the second texture processing is satisfied, a loop processing of steps S9 to S12: NO is repeated. At each time of repetition, an arbitrary line from among the YUV components of the oil-painting-like image is selected, from which a plurality of pixels are selected to be processed, and the small size texture processing is respectively carried out on the plurality of pixels.

After that, when the condition to terminate the second texture processing is satisfied, YES is determined in step S12, and control proceeds to step S13.

In step S13, the storing control unit 59 executes image storing processing of storing the data of an oil-painting-like image acquired by carrying out the two kinds of texture processing in the image storing unit 60. With this, the oil-painting-like image generation processing ends.

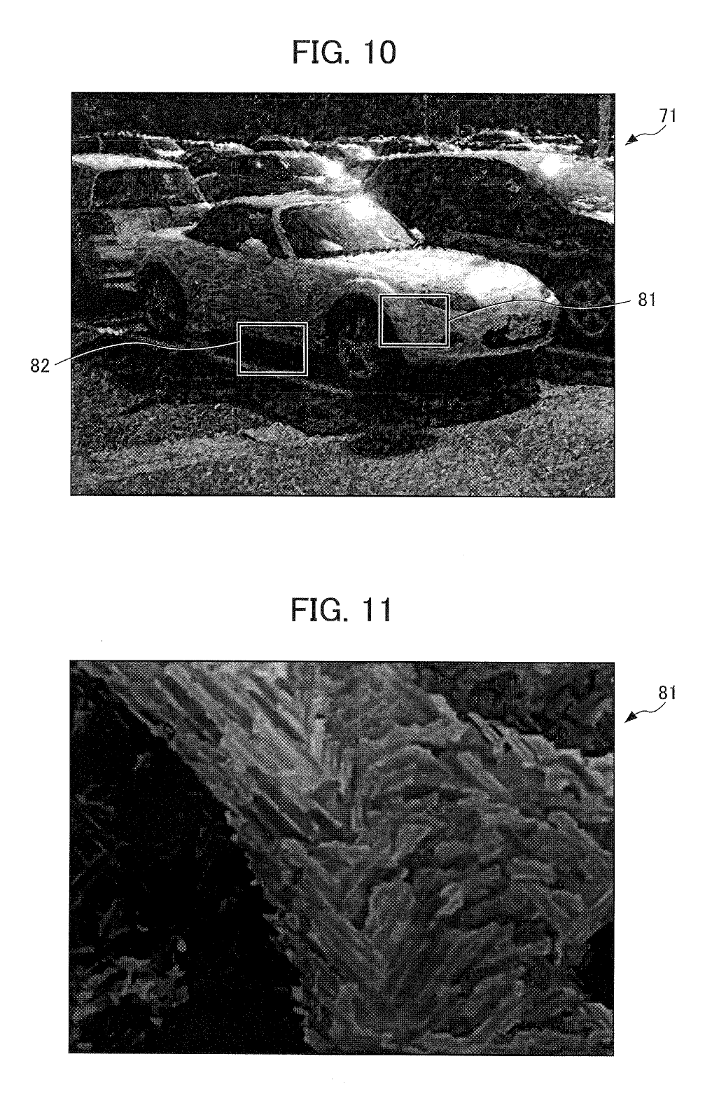

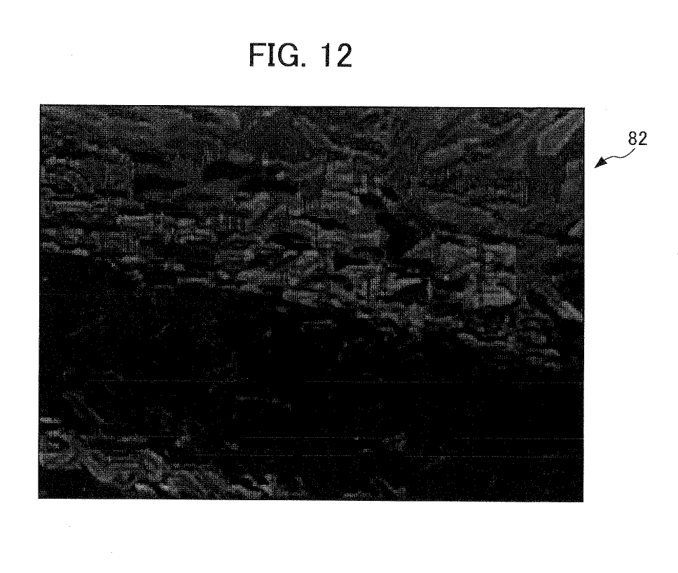

FIG. 10 is a diagram illustrating one example of an oil-painting-like image acquired by the oil-painting-like image generation processing. FIG. 11 is an enlarged view of a partial area 81 of the oil-painting-like image of FIG. 10. FIG. 12 is an enlarged view of a partial area 82 of the oil-painting-like image of FIG. 10 other than the area 81 of FIG. 11.

When the oil-painting-like image generation processing of

FIG. 3 is carried out on data of an original image (not shown) including an automobile as a subject, data of an oil-painting-like image 71 shown in FIG. 10 is generated and stored in the image storing unit 60 (FIG. 2).

Within the oil-painting-like image 71, the area 81 is an area where only the first texture processing is mainly carried out. In the area 81, it can be seen that the edge detection has been executed by way of the Sobel filters, and appropriate textures are selected and added according to the vertical and horizontal components acquired as a result thereof.

On the other hand, within the area 82 in the oil-painting-like image 71, at the boundary of the automobile body, as shown in the enlarged view of FIG. 12, it can be seen that the size of texture is smaller, which means that the second texture processing is carried out for the purpose of complementing the edge portion in addition to the first texture processing.

Thus, in the present embodiment, it can be seen that the second texture processing is carried out only in the vicinity of the edge portion and textures are added only to the edge portion.

Also, as is seen from the oil-painting-like image 71 as a whole shown in FIG. 10, since a method of adding textures on the original image (not shown) is employed in the present embodiment, an oil-painting-like taste is appropriately expressed even if the density of textures is reduced. If it is assumed that textures are added on a white background (not shown), a portion where no texture is added may be easily noticed in a case in which the density of textures is as low as in the present embodiment. On the other hand, as is seen from the oil-painting-like image 71 as a whole shown in FIG. 10, when the oil-painting-like image generation processing of the present embodiment is carried out, a portion where no texture is added is hardly noticed, since colors of the original image are preserved in such a portion.

Also, reduction of texture density can lead to an increase in processing efficiency.

Thus, by carrying out the oil-painting-like image generation processing of the present embodiment, it becomes possible to generate data such as of the oil-painting-like image 71 with enhanced artistically creative effects in consideration of the edge intensity of an original image in horizontal and vertical directions as a whole.

It should be noted that the present invention is not limited to the embodiment described above, and any modifications and improvements thereto within the scope that can realize the object of the present invention are included in the present invention.

For example, though, in the embodiment described above, data of the size the same as the original image is employed as a processing object of the large size processing object selection unit 53, the large size texture processing unit 55, the small size processing object selection unit 56, and the small size texture processing unit 58 of FIG. 2, the present invention is not limited thereto.

More specifically, for example, there is a case in which it is difficult to process textures of a large size due to the limited memory size of the RAM 13 and the like of the image capturing apparatus 1 of FIG. 1, and yet it is required to process textures of a size more than the memory size for the purpose of expressing a creative effects as if painted with a brush. In such a case, reducing processing may be carried out on the YUV components outputted from the image conversion unit 52, the data of the reduced size image thus acquired may be supplied to the large size processing object selection unit 53. In this case, it is necessary to enlarge the data outputted from the small size texture processing unit 58 into the size of the original image.

Furthermore any functional block other than the functional blocks shown in FIG. 2 may be added if required. More specifically, for example, when the reduced data of an image to be processed is enlarged as is described above, there is a case in which jaggy noise arises in the image after being enlarged. Therefore, in order to remove such jaggy noise, a functional block of applying DMF (Directional Median Filter) to Y component from among YUV components of the oil-painting-like image outputted from the small size texture processing unit 58 can be added.

Furthermore, for example, in the embodiment described above, as a method used for the large size orientation decision unit 54 and the small size orientation decision unit 57 to compute edge intensity, a method of applying Sobel filters to the Y component, which has been outputted from the image conversion unit 52 and reduced to QVGA size, is employed due to the limited memory size and for the purpose of enhancing processing speed. However, the present invention is not limited to this.

More specifically, for example, a method of applying Sobel filters to the Y component outputted from the image conversion unit 52, as it is, without any size reduction, can be employed. In this case, it is equivalent to a larger size Sobel filter being applied, and the processing accuracy is enhanced.

Furthermore, if an increase in speed is required, a method can be employed that acquires edge intensity by applying any kind of filter such as a Laplacian filter, other than the Sobel filter, to the Y component outputted from the image conversion unit 52 or reduced data thereof.

Furthermore, in the embodiment described above, although a description has been given in which the texture processing is carried out twice, there is no limitation to the number of times the texture processing is executed. The texture processing may be carried out only once, or conversely, may be carried out 3 times or more.

Furthermore, a description has been given in the embodiment in which the image processing apparatus according to the present invention is configured by an image capturing apparatus such as digital camera. However, the present invention is not limited to an image capturing apparatus and can be applied to any electronic device that can carry out the image processing described above regardless of whether with or without image capturing function. More specifically, the present invention can be applied to a personal computer, a video camera, a portable navigation device, a portable game device, and the like.

The series of processing described above can be executed by hardware and also can be executed by software.

In a case in which the series of processing are to be executed by software, a program configuring the Software is installed from a network or a storage medium into a computer or the like. The computer may be a computer incorporated in dedicated hardware. Alternatively, the computer may be capable of executing various functions by installing various programs, i.e. a general-purpose personal computer, for example.

The storage medium containing the program can be constituted not only by the removable media 31 of FIG. 1 distributed separately from the device main unit for supplying the program to a user, but also can be constituted by a storage medium or the like supplied to the user in a state incorporated in the device main body in advance. The removable media is composed of a magnetic disk (including a floppy disk), an optical disk, a magnetic optical disk, or the like, for example. The optical disk is composed of a CD-ROM (Compact Disk-Read Only Memory), a DVD (Digital Versatile Disk), or the like. The magnetic optical disk is composed of an MD (Mini-Disk) or the like. The storage medium, supplied to the user in a state in which it is incorporated in the device main body in advance, may include the ROM 12 of FIG. 1 in which the program is stored, a hard disk included in the storing unit 19 of FIG. 1, and the like, for example.

It should be noted that in the present specification the steps describing the program stored in the storage medium include not only the processing executed in a time series following this order, but also processing executed in parallel or individually, which is not necessarily executed in a time series.

What is claimed is:

1. An image processing apparatus comprising:
an input unit that inputs data of an image;
a conversion unit that converts the data of the image inputted by the input unit into a form including a color space having a luminance component;
a selection unit that selects data of a plurality of pixels from data of the image converted by the conversion unit;
a first determining unit that determines orientation of a brush stroke pattern for texture processing based on an edge intensity of each predetermined unit of pixel of the image, in horizontal and vertical directions;
a first texture processing unit that carries out the texture processing on data of the plurality of pixels selected by the selection unit using colors of the pixels, with the brush stroke pattern of the orientation determined by the first determining unit; and
a storing control unit that controls storing the data of the image including a result of processing carried out by the first texture processing unit.

2. An image processing apparatus as set forth in claim 1, further comprising:
a second determining unit that determines orientation of a brush stroke pattern smaller than the brush stroke pattern determined by the first determining unit based on an edge intensity of each predetermined unit of pixel of the image, in horizontal and vertical directions; and
a second texture processing unit that carries out the texture processing on data of the image after processing by the first texture processing unit, with the brush stroke pattern of the orientation determined by the second determining unit; wherein
the storing control unit controls storing the data of the image including a result of processing carried out by the second processing unit in addition to a result of processing carried out by the first texture processing unit.

3. An image processing apparatus as set forth in claim 1, wherein the brush stroke pattern is a brush-like pattern.

4. An image processing apparatus as set forth in claim wherein
the input unit includes an image capturing apparatus.

5. A storage medium having stored therein an image processing program causing a computer to perform image processing on data of an image inputted therein to function as:
a conversion function that converts the data of the image inputted therein into a form including a color space having a luminance component;
a selection function that selects data of a plurality of pixels from data of the image converted by the conversion function;
a determining function that determines orientation of a brush stroke pattern for texture processing based on an edge intensity of each predetermined unit of pixel of the image, in horizontal and vertical directions;
a texture processing function that carries out the texture processing on data of the plurality of pixels selected by the selection function using colors of the pixels, with the brush stroke pattern of the orientation determined by the determining function; and
a storing control function that controls storing the data of the image including a result of processing carried out by the texture processing function.
